(19) United States
(12) Patent Application Publication
(10) Pub. No.: US 2023/0125767 A1
(43) Pub. Date: Apr. 27, 2023

(54) FLAT SECURITY ELEMENT WITH OPTICAL SECURITY FEATURES

(71) Applicant: HUECK FOLIEN GESELLSCHAFT M.B.H., Baumgartenberg (AT)

(72) Inventor: Stephan TRAßL, Baumgartenberg (AT)

(73) Assignee: HUECK FOLIEN GESELLSCHAFT M.B.H., Baumgartenberg (AT)

(21) Appl. No.: 17/911,752

(22) PCT Filed: Mar. 15, 2021
(86) PCT No.: PCT/EP2021/056474

§ 371 Date: Sep. 15, 2022

(30) Foreign Application Priority Data
Mar. 16, 2020 (AT) A 50225/2020

(51) Int. Cl. B42D 25/324; B42D 25/328; B42D 25/378

(52) U.S. Cl. CPC B42D 25/324; B42D 25/328; B42D 25/378; B42D 25/364

(57) ABSTRACT

A flat security element with optical security features includes at least one first surface region with a first sub-wavelength structure. The structure elements that define the first sub-wavelength structure periodically repeat in the plane of the security element. In order to be able to convey a motif with increased forgery protection using at least two different color impressions, which motif is easy to produce, the first sub-wavelength structure of at least one partial region of the first surface region is additionally provided with an interference coating for producing a color-shifting effect.

### FIELD OF THE INVENTION

The invention relates to a flat security element with optical security features, comprising at least one first surface region with a first sub-wavelength structure, wherein the structure elements that define the first sub-wavelength structures periodically repeat in the plane of the security element. The periodic repeating can occur in one direction, that is, in one dimension, for example if a structure element comprises a straight wall and multiple walls of this type are periodically arranged next to one another. The periodic repeating can occur in two directions, that is, in two dimensions, for example if a structure element comprises a column and multiple columns are arranged in a grid pattern, or if one structure element comprises a depression and multiple recesses are arranged in a grid pattern.

### PRIOR ART

Relevant security elements which comprise sub-wavelength structures are known from DE 10 2012 015 900 A1. Namely, the flat security element comprises in a first surface region what is referred to as a ground element structure, which due to the sub-wavelength structure conveys different color impressions from the front and back sides in a plan view, and also comprises the ground element structure in a second surface region, but in a form mirrored from the first surface region, whereby the first and second region show a motif from both sides in a plan view, but the motif is not recognizable in a transmission view. To realize the ground element structure, a grating ground structure in the first surface region and an inverted grating ground structure in the second surface region are then disclosed in a first variant. As a second variant, a substrate with interference coatings inverted from one another is shown in the first and in the second surface region.

DE 10 2012 015 900 A1 thus makes it possible to convey a motif in a plan view, that is, when there is reflection on a surface of the security element, using two different color impressions as a result of the two different surface regions with a ground element structure inverted from one another.

### SUMMARY OF THE INVENTION

It is an object of the invention to provide an alternative security element with optical security features, which element exhibits an increased forgery protection, is easy to produce, and can also convey a motif using at least two different color impressions.

The starting point of the invention is a flat security element with optical security features, comprising at least one first surface region with a first sub-wavelength structure, wherein the structure elements that define the first sub-wavelength structure periodically repeat in the plane of the security element. In order to alter the color effect that is produced by a sub-wavelength structure, it is envisaged that the first sub-wavelength structure of at least one partial region of the first surface region is additionally provided with an interference coating for producing a color-shifting effect.

In the color-shifting effect, the color impression changes with the viewing angle; that is, the interference coating changes the color depending on the viewing angle.

This additional interference coating causes a further change in the color effect that results from the sub-wavelength structure. Because the effects overlap due to the sub-wavelength structure and the interference coating, this cumulative effect is difficult to produce using other methods, which increases the forgery protection of the security element according to the invention.

In this case, a thin-layer arrangement Which causes a color-shifting effect by means of thin-layer interference is to be understood as an interference coating for producing a color-shifting effect. Security elements which are based on thin-layer interference are known from EP 1 558 449 A, for example. An interference coating for producing a color-shifting effect, hereinafter referred to in short as interference coating, is normally composed of at least two partial layers: one dielectric layer and one absorber layer. An additional reflective layer on the other side of the dielectric layer, that is, opposite from the absorber layer relative to the dielectric layer, reflects electromagnetic waves, light in the visible range in this case, and thereby intensifies the interference effect. The dielectric layer serves as a spacer layer, if need be between the reflective layer and absorber layer. The color-shifting effect emerges when the interference coating is viewed from the absorber layer side, that is, when light falls onto the dielectric layer through the absorber layer.

For the dielectric layer of the interference coating, dielectric materials with a refractive index less than or equal to 1.65 are possible, for example aluminum oxide (Al₂O₃), metal fluorides, for example magnesium fluoride (MgF₂), aluminum fluoride (AlF₃), silicon oxide (SiOₓ), silicon dioxide (SiO₂), cerium, fluoride (CeF₃), sodium aluminum fluoride (for example, Na₃AlF₆ or Na₅Al₃F₁₄), neodymium fluoride (NdF₃), lanthanum fluoride (LaF₃), samarium fluoride (SmF₃), barium fluoride (BaF₂), calcium fluoride (CaF₂), lithium fluoride (LiF), low-refractive organic monomers, and/or low-refractive organic polymers.

However, for the dielectric layer of the interference coating, dielectric materials with a refractive index greater than 1.65 are also possible, for example zinc sulfide (ZnS), zinc oxide (ZnO), titanium dioxide (TiO₂), carbon (C), indium oxide (InO₃), indium tin oxide (ITO), tantalum )pentoxide (Ta₂O₅), cerium oxide (CeO₂), yttrium oxide (Y₂O₃), europium oxide (Eu₂O₃), iron oxides such as iron (II,III) oxide (Fe₃O₄) and iron (M) oxide (Fe₂O₃) for example, hafnium nitride (HfN), hafnium carbide (HfC), hafnium oxide (HfO₂), lanthanum oxide (La₂O₃), magnesium oxide (MgO), neodymium oxide (Nd₂O), praseodymium oxide (Pr₆O₁₁), samarium oxide (Sm₂O₃), antimony trioxide (Sb₂O₃), silicon carbide (SiC), silicon nitride (Si₃N₄), silicon monoxide (SiO), selenium trioxide (Se₂O₃), tin oxide (SnO₂), tungsten trioxide (WO₃), high-refractive organic monomers, and/or high-refractive organic polymers.

A metallic layer can be used as an absorber layer of the interference coating, with this being a pure metal layer or a layer containing metallic clusters, for example. Preferably, the absorber layer comprises at least one metal of the group composed of aluminum, gold, titanium, vanadium, cobalt, tungsten, niobium, iron, molybdenum, palladium, platinum, chromium, silver, copper, nickel, tantalum, tin, and/or alloys thereof, for example gold/palladium, copper/nickel, copper/aluminum, or chromium/nickel.

If necessary, a metallic layer can be used as a reflective layer of the interference coating, which metallic layer preferably at least one metal selected from the group composed of aluminum, gold, chromium, silver, copper, tin, platinum, nickel, and alloys thereof, for example nickel/chromium or copper/aluminum. It is likewise possible that the reflective layer contains a semiconductor such as silicon, for example. Finally, it is also possible that the reflective layer is produced by applying an ink with metallic pigments, preferably of a metal from the aforementioned group. The reflective layer is applied completely or partially over the entire area using known methods, such as spraying, vapor deposition, sputtering, or for example as ink using known printing methods (intaglio printing, flexographic printing, silkscreen printing, digital printing), by lacquering, roller coating methods, slot-die coating, methods, rolldip coating methods, or curtain coating methods and the like.

What are referred to as HRT layers (high-refractive index layers) that comprise a material with a refractive index greater than 1.5 can also be used as reflective layer of the interference coating. URI layers of this type comprise, for example, dielectric materials with a refractive index of greater than or equal to 1.65, for example zinc sulfide (ZnS), zinc oxide (ZnO), titanium dioxide (TiO₂), carbon (C), indium oxide (In₂O₃), indium tin oxide (ITO), tantalum pentoxide (TaO₅), cerium oxide (CeO₂), yttrium oxide (Y₂O₃), europium oxide (EmO₃), iron oxides such as iron(II,III) oxide (Fe₃O₄) and iron(III) oxide (Fe₂O₃) for example, hafnium nitride (HIN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon carbide (SiC), silicon nitride (Si₃N₄), silicon monoxide (SiO), selenium trioxide (Se₂O₃), tin oxide (SnO₂), tungsten trioxide (WO₃), high-refractive organic monomers, and/or high-refractive organic polymers. These materials can either be vapor deposited or printed on (particularly the monomers and polymers).

However, cholesteric liquid crystal layers combined with a dark, preferably black, printed layer or metallization can also be used as interference coating for producing a color-shifting effect. Printed layers with interference pigments or liquid crystal pigments can also be used as interference coating for producing a color-shifting effect.

The feature according to which the first sub-wavelength structure of at least one partial region of the first surface region is additionally provided with an interference coating for producing a color-shifting effect means that the interference coating can cover said first surface region merely partially or even totally. If only a partial region of the first surface region is provided with an interference coating, two different colors are discernable in the first surface region. If the entire first surface region is provided with the interference coating, then at a certain viewing angle the surface region appears in only one color, but said color is difficult to reproduce for different viewing angles since it changes into a second color at at least one other viewing angle.

In any case, the invention also comprises the aspect that, per security element, there can be multiple first surface regions with a first sub-wavelength structure. In this manner, patterns can be produced from multiple separate pattern elements or lettering can be produced from multiple letters, for example. All possible variations of first surface regions are then possible: one or more first surface regions that are fully provided with an interference coating, and/or one or more first surface regions that are only partially provided with an interference coating.

A flat security element has a small height or thickness compared to its length and width. A flat security element can be a film or a sheet, for example. The flat security element will normally have a consistent height or thickness. The first and second surfaces which form the front and back sides of the security element will normally be planar and be arranged parallel to one another. The sub-wavelength structures will normally run parallel to the plane of the security element; this means that the directions of the periodic repeating of the structure elements lie parallel to the plane of the security element, whereas the structure elements themselves, such as columns or depressions, can, of course, also extend perpendicularly to the plane of the security element and will normally also do so.

Here, sub-wavelength structures are understood as structures which are constructed from structure elements that periodically repeat at least in one plane of the security element, wherein a dimension of the individual structure element lies below the wavelength of the light used. The periodic repeating of the structure elements can occur in one direction, that is, in one dimension, or in two directions, that is, in two dimensions. For example, two-dimensionally periodic column structures or two-dimensionally periodic hole structures, as are explained in DE 10 2012 015 900 A1 for instance, are known as a sub-wavelength structure. The columns thereby project away from a layer, whereas the holes are realized by recesses in a layer. In this sense, columns are the negative form of the holes. The diameter of the column or of the hole in the hole structure thereby lies below the wavelength of the light used for illumination; this is normally visible light. The height of the column or the depth of the hole is chosen such that specific wavelengths are canceled and the reflected (and possibly transmitted light) thus has a color different from the incident light, normally white light. Another possibility would be to produce additional plasmons and thus achieve an additional color shift of the light; for this purpose the sub-wavelength structures are realized with the use of thin metal layers. This means that, in the case of a column structure, the tops of the columns and the surface between the columns that is located at the height of the bottom of the columns bear a metal layer, but not the lateral surfaces of the columns, to the extent this is possible given the production conditions. Similarly, in the case of hole structures, the surfaces in which the holes are located and the bottom of the holes would bear a metal layer, but not the walls of the holes, to the extent this is possible given the production conditions.

The sub-wavelength structure is normally formed primarily by a lacquer layer, of UV lacquer for example, the surface of which is provided with a nanostructure, for example by means of an embossing method. The interference coating according to the invention is then applied to this structured lacquer layer. If the interference coating is a thin-layer arrangement comprising an absorber layer, a dielectric layer, and a reflective layer, the metallic reflective layer could be used to additionally excite surface plasmons. Optionally, a thin dielectric layer can also be applied between the lacquer layer and metallic reflective layer.

If no metallic reflective layer is available, for example because the interference coating is not a thin-layer arrangement with dielectric and absorber and reflective layers, it would also be possible that—before the application of the interference coating—an additional metal layer is applied to the sub-wavelength structure to excite surface plasmons. Optionally, a thin dielectric layer can also be applied between the lacquer layer and the additional metallic layer.

The deposition of the metallic reflective layer or the additional metal layer should preferably take place directionally, for example by thermal vapor deposition or sputter deposition. As a result of the directional deposition of the metal, small metallic disks form on the bottom of the holes or on the columns, whereas a perforated apertured film forms in the remaining region. By electrically separating the small metallic disks and the perforated apertured film, surface plasmons can be excited by incident light. The excitation of the surface plasmons causes increased reflection and absorption in certain spectral ranges, which is associated with a coloring. The additional metal layer of the sub-wavelength structure can be constructed from Al, Cu, Ag, Au, Pd, Pt, Sn, In, or alloys thereof.

After the application of the interference coating, the sub-wavelength structure coated with the interference coating can be filled in, for example with the same lacquer from which the sub-wavelength structure is constructed.

The periodicity of the sub-wavelength structure can lie in the range of 200-500 nm; the diameter of the columns and holes or the grating openings can lie in the range of 100-300 nm. The height of the columns and the depth of the holes can lie between 30 and 400 nm, in particular in the range of 150-250 nm, for example around 200 nm.

If the interference coating is a thin-layer arrangement with a dielectric and absorber layer, then the dielectric layer typically has a thickness in the range of 100-500 nm. The thickness of the absorber layer typically lies in the range of 5-10 nm. The optional reflective layer of the thin-layer arrangement can typically have a thickness of 20-50 nm. Also possible would be a thickness below 20 nm, for example of 5-10 nm, though the reflective property is less in this case. If the interference coating is not a thin-layer arrangement, the optional additional metal layer for the excitation of surface plasmons can have a thickness of 5 to 100 nm, preferably a thickness below 40 nm, particularly preferably a thickness below 20 nm, for example of 5-10 nm.

In addition, the security element can also comprise one or more surface regions which have neither a sub-wavelength structure nor an interference coating. These regions can then be imprinted with color and/or information or be provided with other security features, for example.

In one embodiment of the invention, it is provided that an unstructured surface region lies adjacent to a first surface region, which unstructured surface region does not have a sub-wavelength structure, but has, at least in one partial region, the same interference coating as at least one partial region of the first surface region. There is thus at least one first surface region with a sub-wavelength structure and one surface region adjacent thereto without a sub-wavelength structure, wherein both surface regions are partially, in particular completely, provided with the same interference coating. Thus, at least one continuous interference coating is present, for example, which covers surface regions having a sub-wavelength structure as well as surface regions without a sub-wavelength structure. In particular, a single continuous interference coating can cover all first surface regions of a sub-wavelength structure and all surface regions without a sub-wavelength structure. The single continuous interference coating can thereby extend over the entire flat security element. A continuous interference coating can be fabricated more easily than multiple, separate surface regions with an interference coating.

If a corresponding amount of correspondingly small first surface regions and a corresponding amount of correspondingly small unstructured surface regions are used, high-resolution two-colored images can be produced therewith,

In one embodiment of the invention, it is provided that the security element comprises, in additional to a first surface region with a first sub-wavelength structure, at least one second surface region with a second sub-wavelength structure, with the first surface region being arranged beside the second surface region, wherein the structure elements which define the first and second sub-wavelength structures and that periodically repeat in the plane of the security element are different for both surface regions.

In this case, three different colors can even be produced in incident light for a certain viewing angle, one by the first sub-wavelength structure of the first surface region, one by the second sub-wavelength structure of the second surface region, and one by the additional interference coating in a partial region of the first surface region. If the entire first surface region is covered with the same interference coating, only two different colors can be made to appear for a certain viewing angle, but the color of the first surface region, which color changes for different viewing angles, is difficult to reproduce.

In another embodiment of the invention, it is provided that the security element comprises, in addition to a first surface region with a first sub-wavelength structure, at least one second surface region with a second sub-wavelength structure, with the first surface region being arranged beside the second surface region, wherein the structure elements which define the first and second sub-wavelength structures and that periodically repeat in the plane of the security element are the same for both surface regions, but are oriented towards a first surface of the security element in the first surface region and are oriented towards a second surface of the security element in the second surface region, which second surface is opposite from the first surface.

Thus, if one were to mirror the first sub-wavelength structure of the first surface region on a plane that runs parallel to the plane of the security element in the security element and then move it into the second surface region along this mirror plane, one would obtain the second sub-wavelength structure of the second surface region.

In this case, three different colors can also be produced in incident light, one by the first sub-wavelength structure of the first surface region, one by the second sub-wavelength structure of the second surface region, and one by the additional interference coating in a partial region of the first surface region.

If the entire first surface region is covered with the same interference coating, only two different colors can be made to appear for a certain viewing angle, but the color of the first surface region, which color changes for different viewing angles, is difficult to reproduce.

In a further design of the two embodiments having two different sub-wavelength structures or two sub-wavelength structures inverted from one another, it can be provided that the second sub-wavelength structure of at least one portion of the second surface region is additionally provided with an interference coating for producing a color-shifting effect. In this manner, up to four different colors can be produced in incident light for a certain viewing angle, since in the second surface region, the partial arrangement of an interference coating also causes a change in the reflected light in this region of the second surface region. In terms of construction, the interference coating can be designed in the same manner for the first and the second surface regions, that is, can exhibit the same optical behavior. Thus, the interference coating could, for example, completely fill the first and the second surface regions. The security element would then show two colors at a certain viewing angle, which colors are each difficult to reproduce.

However, the interference coating could also have a different layer construction (for example, a different thickness of the spacer layer) in the first surface region than in the second surface region, so that the interference coating in the second surface region produces a different optical behavior, and thus a different color, than that in the first surface region.

Of course, for each surface region, that is, on the same sub-wavelength structure, different interference coatings can also be applied beside one another in order to produce, for example due to the different layer construction of the interference coatings, correspondingly different colors for each surface region. Accordingly, it is provided in one embodiment of the invention that the first sub-wavelength structure of a first surface region and/or possibly the second sub-wavelength structure of a second surface region comprise two or more different interference coatings for producing a color-shifting effect beside one another. The term “different interference coatings” is to be understood as meaning that these coatings respectively achieve a different color effect. For this purpose, the different interference coatings can be constructed according to the same principle, for instance, they could all comprise a thin-layer arrangement with at least an absorber and dielectric layer, but could differ in terms of the material and/or thickness of the dielectric layer. Or, the different interference coatings can use different principles, for example in that one interference coating comprises a thin-layer arrangement, another interference coating a cholesteric liquid crystal layer or layers with interference pigments or liquid crystal pigments.

It can be provided that at least one first surface region (with a first sub-wavelength structure) is arranged adjacently to a second surface region (with a second sub-wavelength structure). The first and second surface regions can thus be directly adjacent to one another, which enables the creation of a contiguous, forgery-proof motif, or can be arranged spaced apart from one another, which enables the placement of additional security features between the two surface regions.

In particular, it can be provided that the first surface region is arranged spaced apart from the second surface region, wherein an unstructured surface region that does not have a sub-wavelength structure lies between the first and second surface regions.

In one embodiment of the invention, it is provided that the structure elements which define the first and second sub-wavelength structures comprise columns or holes and the plane of the top surfaces of the columns in the first surface region corresponds to the plane of the surrounding surfaces of the columns in the second surface region, or that the plane of the bottoms of the holes in the first surface region corresponds to the plane of the surrounding surfaces of the holes in the second surface region.

In one embodiment of the invention, it is provided that the interference coating is applied directly to the sub-wavelength structure at least in one surface region. The interference coating is normally applied directly to the sub-wavelength structure. Conversely, the sub-wavelength structure can also be applied to the interference coating. In both cases, there are no other layers between the sub-wavelength structure and interference coating; the sub-wavelength structure and interference coating lie directly next to one another. However, it would also be possible that one or more other layers are located between the sub-wavelength structure and interference coating.

In one embodiment of the invention, it is provided that the effective depth of the sub-wavelength structure is smaller than the thickness of the interference coating. The effective depth corresponds to the height of the structure elements. For columns, the effective depth is the height of the column; for holes, the effective depth is the depth of the hole in the case of a thin-layer arrangement without a reflective layer, the thickness of the interference coating corresponds to the sum of the thicknesses of the dielectric layer and absorber layer. In the case of a thin-layer arrangement with a reflective layer, the thickness of the interference coating corresponds to the sum of the thicknesses of the dielectric layer, absorber layer, and reflective layer.

The security element according to the invention normally comprises a carrier substrate on which the sub-wavelength structure and the interference coating are applied. Possible carrier substrates, for example, are transparent carrier films, preferably flexible plastic films, for example of polyimide (PI), polypropylene (PP), monoaxially oriented polypropylene (MOPP), biaxially oriented polypropylene (BOPP), polyethylene (PE), polyphenylene sulfide (PPS), polyether ether ketone (PEEK), polyether ketone (PEK), polyethylene imide (PEI), polysulfone (PSS), polyaryl ether ketone (PAEK), polyethylene naphthalate (PEN), liquid crystal polymers (LCP), polyester, polybutylene terephthalate (PBT), polyethylene terephthalate (PET), polyamide (PA), polycarbonate (PC), cyclooletin copolymers (COC), polyoxymethylene (POM), acrylonitrile butadiene styrene (ABS), polyvinyl chloride (PVC), ethylene tetrafluoroethylene (ETFE), polytetrafluoroethylene (PTFE), polyvinyl fluoride (PVF), polyvinylidene fluoride (PVDF), and ethylene-tetrafluoroethylene-hexafluoropropylene-fluoroterpolymer (EFEP). The carrier films can be transparent, translucent, semi-opaque, or opaque.

The carrier substrate preferably has a thickness of 5-700 μm, preferably 5-200 μm, particularly preferably 5-50 μm.

The security element, containing the sub-wavelength structure and the interference coating, can, on one or both surfaces, also be surface-treated, coated or laminated, for example coated or laminated with plastics, or lacquered, in order to protect the security features present on the security element against mechanical, physical, and/or chemical influences. A protective lacquer coating can, for example, be constructed based on nitrocellulose, acrylates and copolymers thereof, polyamides and copolymers thereof, polyvinyl chlorides and copolymers thereof, or can be composed of a crosslinked lacquer. Furthermore, the security element can be provided with an adhesive layer on one or both sides in order to enable a fixing on or in a data storage device or value document. This adhesive layer can be embodied either in the form of a hot-seal coating, cold-seal coating, or self-adhesive coating.

The security features according to the invention, which are formed by sub-wavelength structures and interference coatings, can thereby be applied to the carrier substrate in order to create the security element. This security element can then be custom-fabricated, before or after a surface treatment, and be at least partially embedded in a data storage device or value document, or applied to a data storage device or value document, as a ribbon, strand, or patch. In this sense, the invention also comprises a data storage device or a value document, for example a bank note, which comprises a security element according to the invention.

### BRIEF DESCRIPTION OF THE DRAWINGS

The invention will now be explained in greater detail with the aid of schematic drawings which depict the exemplary embodiments of device according to the invention. The following are thereby shown:

FIG. 1 a top view of a flat security element according to the invention, still without interference coating;

FIG. 2 a top view of the security element from FIG. 1, with interference coating;

FIG. 3 a longitudinal section through the security element from FIG. 2 according to the sectional line A-A;

FIG. 4 a longitudinal section through a security element according to the invention with two sub-wavelength structures and an interference coating;

FIG. 5 a longitudinal section through a security element according to the invention with two sub-wavelength structures inverted from one another and an interference coating.

### WAYS OF EMBODYING THE INVENTION

FIG. 1 shows the top view of a flat security element 4, which is rectangular in this case. In a first surface region 1, it comprises a first sub-wavelength structure. In the adjacent surface region, no sub-wavelength structure is provided; this is an unstructured surface region 3. The boundary between the two surface regions 1, 3 is formed by the diagonal of the rectangle.

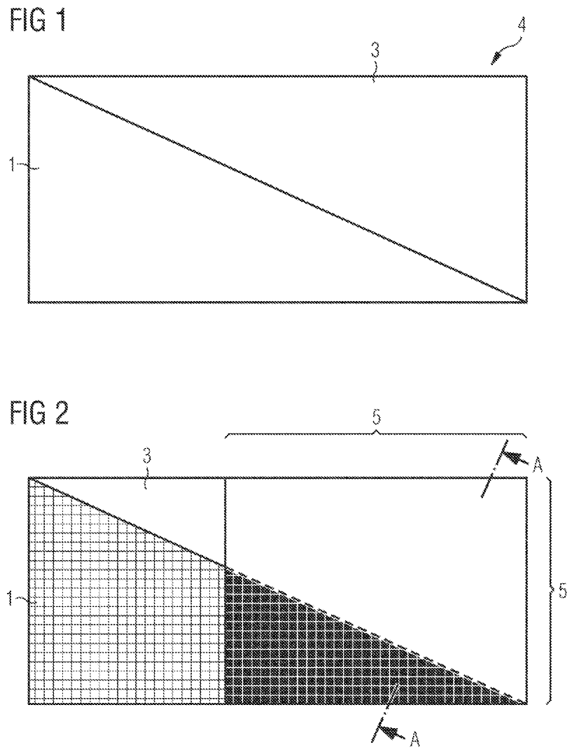

In order to provide the security element 4 with the feature of the interference coating 5 according to the invention, an interference coating 5 is then applied in a rectangular partial region of the security element 4, but not in the remaining portion of the security element 4; see FIG. 2, where an interference coating 5 covers slightly more than the right half of the security element 4. In this case, the interference coating 5 has the same properties everywhere, that is, is an identically designed interference coating shared by both surface regions 1, 3. The interference coating 5 thus has the same thickness and the same construction everywhere. In this manner, it is still possible to achieve four different color effects.

Of course, one or more differently shaped first surface regions I with a first sub-wavelength structure can be present on a security element 4, and many separate first surface regions 1 with a first sub-wavelength structure can be present, wherein one contiguous or many separate unstructured surface regions 3 can be located between and/or around these first surface regions

In this case, all surface regions 1, 3 can thereby be provided with the same continuous interference coating 5, or only some surface regions 1, 3 can be completely or partially covered with a contiguous, full-area interference coating 5. Or, multiple separate regions can be provided with an interference coating 5 which only cover the first surface regions 1 congruently. Or, the region(s) of the interference coating 5 do not completely overlap with first surface regions 1 and from a pattern independent thereof.

The security element 4 illustrated can be part of a value document, for example can cover a partial area of a value document.

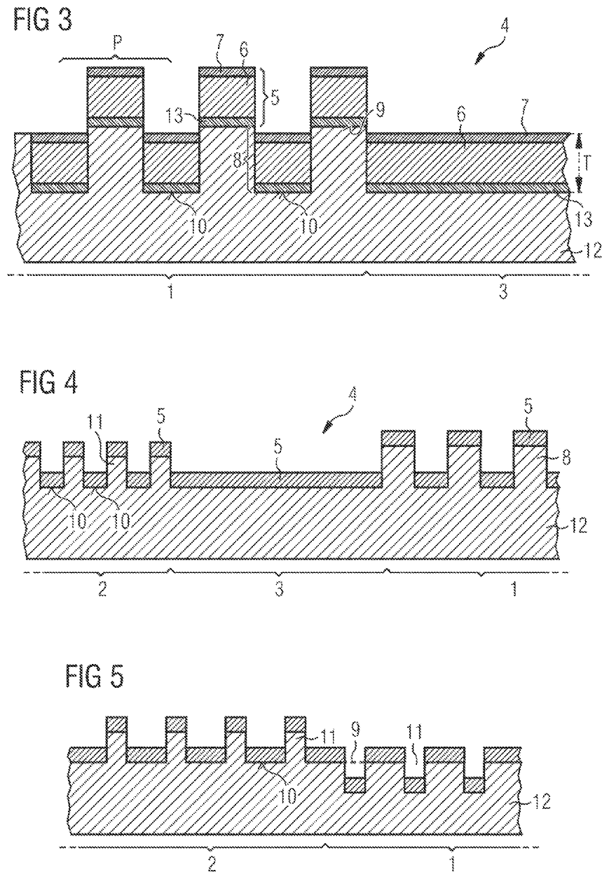

FIG. 3 shows a longitudinal section through the security element 4 in order to display the construction of the sub-wavelength structure and of the interference coating 5. The plane of the security element 4 thus runs horizontally here. The first sub-wavelength structure is provided in the first surface region 1. This structure is composed of columns 8 that periodically repeat in two directions with one period P each. In this case, only the period P in the direction from left to right in the drawing plane is visible. The period in the direction perpendicular to the drawing plane can be the same as or different from that in the drawing plane. The height of the columns 8 corresponds to the effective depth T of the sub-wavelength structure. The columns 8 can have any desired cross section, for example, circular, oval, rectangular, or square. The cross section should, to the extent possible under production conditions, ideally be constant over the height of the column 8.

On the sub-wavelength structure of the first surface region 1 and on the unstructured surface region 3, the interference coating 5 is then applied, which in this case is composed of three layers: The reflective layer 13 is applied directly to the top surface 9 of the column 8, to the surrounding surface 10 of the column 9, and to the surface of the unstructured surface region 3. The dielectric layer 6 is then applied to this reflective layer 13. The absorber layer 7 is applied to the dielectric layer 6. The reflective layer 13 could optionally be omitted. A coating or lamination can then be applied to the absorber layer 7.

With the, normally metallic, reflective layer 13 of the interference coating 5, plasmonic effects can also be excited.

Light would, in this case, fall on the security element from above; the color effect that is caused by the sub-wavelength structure together with the interference coating would accordingly be visible in the reflected light, that is, from above. Light could also fall on the security element from below (if the carrier substrate 12 is translucent); the color effect that is caused by the sub-wavelength structure would likewise accordingly be visible in the reflected light, that is, from below. A color effect in transmission (if the carrier substrate 12 is translucent) is not precluded, however.

FIG. 4 shows a longitudinal section through a security element 4 that comprises two different sub-wavelength structures. The first sub-wavelength structure is provided in the first surface region 1. In the second surface region 2, a second sub-wavelength structure is provided Which differs from the first in that the columns thereof 11 are less high and wide. These columns 11 also periodically repeat in two directions with one period each, which in the drawing plane can be the same as or different from that Which is perpendicular to the drawing plane. The period of the sub-wavelength structure of the first surface region I can be different from that of the second surface region 2. The two surface regions 1, 2 with sub-wavelength structures are separated by an unstructured surface region 3 without sub-wavelength structures. All three surface regions 1-3 are provided with the same interference coating 5.

In this manner, it is possible to convey, at different viewing angles, up to six different color impressions, two different color impressions each per surface region 1-3. If the first surface region 1 and/or the second surface region 2 are not completely covered with an interference coating 5, that is, in FIG. 4 for example the regions lying further to the left or right no longer bear an interference coating 5, two different color impressions per structured surface region 1, 2 can also be achieved at the same viewing angle.

However, the unstructured surface region 3 could also be omitted, so that the first surface region 1 and second surface region 2 are directly adjacent to one another. Additional surface regions, also with other sub-wavelength structures, can also be provided.

FIG. 5 shows a longitudinal section through a security element 4 that comprises two different sub-wavelength structures. Both sub-wavelength structures are constructed using the same structure elements, namely columns 11, but in this ease the columns 11, which periodically repeat in two directions in the plane of the security element 4, are oriented towards a first surface of the security element 4 in the first surface region 1 and are oriented towards a second surface of the security element 4 in the second surface region 2, which second surface is opposite from the first surface. Both surface regions 1, 2 are provided with the same interference coating 5. The two surface regions 1, 2 with sub-wavelength structures could also be separated by an unstructured surface region 3 without sub-wavelength structures.

In this embodiment, the sub-wavelength structure of the second surface region 2 corresponds to that of FIG. 4. Here, the sub-wavelength structure of the first surface region 1 is mirrored from that of the second surface region 2, namely over a plane that is horizontal in this case. The columns 11 of the first surface region 1 are in this case directed downward and form when the depressions in the carrier substrate 12 are filled.

Here, the plane of the top surfaces 9 of the columns 11 in the first surface region 1 lie in the plane of the surrounding surfaces 10 of the columns 11 in the second surface region 1.

### LIST OF REFERENCE SIGNS

First surface region

2 Second surface region

3 Unstructured surface region

4 Security element

5 Interference coating

6 Dielectric layer

7 Absorber layer

8 Column

9 Top surface of the column

10 Surrounding surface of the column

11 Column

12 Carrier substrate

13 Reflective layer

P Period

T Effective depth

1. A flat security element with optical security features, comprising at least one first surface region with a first sub-wavelength structure, wherein the structure elements that define the first sub-wavelength structure periodically repeat in the plane of the security element, wherein the first sub-wavelength structure of at least one partial region of the first surface region is additionally provided with an interference coating for producing a color-shifting effect,
wherein an unstructured surface region lies adjacent to a first surface region, which unstructured surface region does not have a sub-wavelength structure, but has, at least in one partial region, the same interference coating as at least one partial region of the first surface region, and
wherein a motif is conveyed by the first surface region and the unstructured surface region using at least two different color impressions.

2. (canceled)

3. The flat security element according to claim 1, wherein the security element comprises, in addition to a first surface region with a first sub-wavelength structure, at least one second surface region with a second sub-wavelength structure, with the first surface region being arranged beside the second surface region, wherein the structure elements which define the first and second sub-wavelength structures and that periodically repeat in the plane of the security element are different for both surface regions.

4. The flat security element according to claim 1, wherein the security element comprises, in addition to a first surface region with a first sub-wavelength structure, at least one second surface region with a second sub-wavelength structure, with the first surface region being arranged beside the second surface region, wherein the structure elements which define the first and second sub-wavelength structures and that periodically repeat in the plane of the security element are the same for both surface regions, but are oriented towards a first surface of the security element in the first surface region and are oriented towards a second surface of the security element in the second surface region, which second surface is opposite from the first surface.

5. The flat security element according to claim 3, wherein the second sub-wavelength structure of at least one portion of the second surface region is additionally provided with an interference coating for producing a color-shifting effect.

6. The flat security element according to claim 1, wherein the first sub-wavelength structure of a first surface region and/or possibly the second sub-wavelength structure of a second surface region comprise two or more different interference coatings for producing a color-shifting effect beside one another.

7. The flat security element according to claim 1, wherein at least one first surface region is arranged adjacently to a second surface region.

8. The flat security element according to claim 3, wherein the first surface region is arranged spaced apart from the second surface region, wherein an unstructured surface region that does not have a sub-wavelength structure lies between the first and second surface regions.

9. The flat security element according to claim 3, wherein the structure elements that define the first and second sub-wavelength structures comprise columns or holes and the plane of the top surfaces of the columns in the first surface region corresponds to the plane of the surrounding surfaces of the columns in the second surface region, or that the plane of the bottoms of the holes in the first surface region corresponds to the plane of the surrounding surfaces of the holes in the second surface region.

10. The flat security element according to claim 1, wherein the interference coating is applied directly to the sub-wavelength structure at least in one surface region

11. The flat security element according to claim 1, wherein the effective depth of the sub-wavelength structure is smaller than the thickness of the interference coating.

12. A data storage device or value document comprising a security element according to claim 1.
